(19) United States
(12) Patent Application Publication
(10) Pub. No.: US 2019/0317059 A1
(43) Pub. Date: Oct. 17, 2019

(54) HIGH THROUGHPUT BODY FLUID PROTEIN SAMPLE PREPARATION DEVICE AND APPLICATIONS THEREOF

(71) Applicant: DALIAN INSTITUTE OF CHEICAL PHYSICS, CHINESE ACADEMY OF SCIENCES, Dalian, Liaoning (CN)

(72) Inventors: Lihua ZHANG, Dalian, Liaoning (CN); Huiming YUAN, Dalian, Liaoning (CN); Zhongpeng DAI, Dalian, Liaoning (CN); Kaiguang YANG, Dalian, Liaoning (CN); Yukui ZHANG, Dalian, Liaoning (CN)

(21) Appl. No.: 16/462,451

(22) PCT Filed: Jul. 12, 2017
(86) PCT No.: PCT/CN2017/092561

§ 371 Date: May 20, 2019

(30) Foreign Application Priority Data
Nov. 21, 2016 (CN) 201611043531.4

(51) Int. Cl. G01N 30/06; G01N 1/34; G01N 30/72; B01D 63/04; B01D 15/38

(52) U.S. Cl. CPC G01N 30/06; G01N 1/34; G01N 30/7233; G01N 2030/027; B01D 15/3809; G01N 2030/067; B01D 63/046

(57) ABSTRACT

An integrated system has functions of high-abundance protein depletion, on-line denaturation and reduction of middle and low-abundance proteins, desalting and protein digestion. This system includes an antibody column for the depletion of high-abundance protein from body fluids, clustering hollow fiber membranes based high temperature denaturator and reducer, solvent exchanger and immobilized enzymatic reactor. The protein sample from body fluid is firstly treated by antibody column to remove the high-abundance proteins, and then the eluted medium-low abundance protein is subjected to on-line, rapid denaturation and reduction by a high-temperature denaturator and reducer, subsequently the denaturing and the reducing agents in proteins are removed by a solvent exchanger, finally the purified proteins were enzymatically hydrolyzed by an immobilized enzymatic reactor. The peptides produced by the enzymatic hydrolysis can be analyzed by mass spectrometry (MS).

### FIELD OF TECHNOLOGY

The invention relates to a kind of high throughput sample preparation device for the treatment of proteins from body fluid samples, which is an integrated system with combination of high-abundance protein depletion, on-line denaturation and reduction of middle and low-abundance proteins, desalting and protein digestion.

### BACKGROUND

Since proteins in body fluids (plasma, serum, urine, etc.) can provide a large amount of information closely related to physiology and pathology, it is an important means to identify and quantify the proteins excreted into body fluids to reveal pathogenesis and achieve early diagnosis, classification and individualized treatment.

Since a large number and variety of proteins (more than ten thousand) in body fluid are secreted with wide concentration dynamic range (exceed 10 orders of magnitude) from various cells, tissue and organs, therefore, the primary problem to be solved is to reduce interference of high-abundance proteins in body fluids on the detection of low-abundance proteins.

In addition, the amount of body fluid samples available in the clinic for basic research is very limited. At present, the treatment of body fluid proteome samples usually adopts an off-line multi-step method to achieve protein denaturation, reduction, alkylation, enzymatic hydrolysis and desalting. Not only is it time-consuming and laborious, but it also causes loss and contamination of protein samples, which in turn affects the accuracy, sensitivity, and analytical throughput of quantitative proteome analysis. Therefore, there is an urgent need to develop a highly efficient new method for pretreatment of body fluid proteome samples.

In view of the problems existing in traditional sample pretreatment methods, we developed a sample pretreatment system for on-line achieving the depletion of high-abundance proteins from body fluid, and denaturation and reduction, desalting and digestion of medium and low abundance proteins. The system can achieve high throughput sample treatment of low-abundance proteins in body fluids with high recovery, and has a promising application in proteomics research.

### SUMMARY

To solve the above-mentioned problems, the goal of the present invention is to provide a sample pretreatment system that integrates high-abundance protein depletion, medium and low-abundance protein denaturation, reduction, desalting, and on-line enzymatic hydrolysis. The system can handle proteins from body fluids directly, without any manual handling. Meanwhile, the entire process maintains a high degree of continuity and high throughput.

In order to achieve the goal, the technical solution of the present invention is:
1. Two or more hollow fiber membranes are clustered and used as a transport carrier for low-abundance proteins in body fluids, and fixed in a chamber to form protein denaturator and reducer. High-concentration denaturing agents and reducing agents are pumped into the chamber by liquid chromatography pump or peristaltic pump, and rapidly mixed with the proteins, followed by heating by the temperature control system, to achieve fast protein denaturation and reduction, wherein the type of the denaturants may be guanidine hydrochloride or urea, the concentration is 4-8M, and the type of the protein reducing agents may be dithiothreitol, thiol, tris(2-carboxyethyl)phosphine, the concentration is 5-100 mM, the flow rate range of liquid chromatography pump or peristaltic pump is 0.1 mL/min-5 mL/min, Temperature range of heating by temperature control device is 60-95° C.;
2. Two or more hollow fiber membranes are clustered and used as a transport carrier for low-abundance proteins in body fluids, and fixed in chamber to form solvent exchanger. Low-concentration weak alkaline buffer solution is delivered to the chamber through a liquid chromatography pump or a peristaltic pump to replaces the protein solvent with the exchange buffer to achieve protein desalting. The low concentration alkaline buffer solutions may be ammonium hydrogen carbonate or ammonium acetate solution, the concentration range is 10-100 mM, and the pH range is 7.5-8.5, the flow rate of the liquid chromatography pump or peristaltic pump is 0.1 mL/min-5 mL/min;
3. The matrix material of the enzyme reactor is a silica gel particle material with a particle diameter of 10-30 μm; the protease is immobilized on the surface of the material by covalent bonding, the enzyme is trypsin, and the concentration of the enzyme solution is 10-50 mg/mL;
4. The above-mentioned proteins denaturator and reducer, the solvent exchanger and the immobilized enzymatic reactor are sequentially connected in series to construct on-line protein sample pretreatment device: the protein outlet of the hollow fiber membrane on the denaturator and reducer is connected with protein inlet of the hollow fiber membrane on the solvent exchanger, and the outlet of the hollow fiber membrane on the solvent exchanger is connected to the immobilized enzymatic reactor;
5. The inlet of antibody column for high-abundance protein depletion is connected to the liquid chromatography system, and the medium-low abundance proteins eluted from the antibody column directly enter the protein sample pretreatment device, the peptide products can be obtained from outlet of the immobilized enzymatic reactor. And the middle and low-abundance proteins are rapidly cleaved into peptides by the immobilized enzymatic reactor, thereby realizing rapid conversion of the medium-low abundance proteins to the peptides.
6. Peptides from medium-low abundance proteins can be directly detected by mass spectrometry or analyzed by LC/MS system.

The advantages of the present invention are as follows:
1. The manual operation procedures for body fluid protein sample preparation is greatly decreased, therefore the possibility of sample loss and contamination will also be reduced, and the analysis throughput is greatly improved.
2. The system integrates all sample preparation procedures, and could be operated in an automated manner.
3. This system can be online combined with the separation and identification technology, to provide technical support for high-throughput protein analysis.

### BRIEF DESCRIPTION OF THE DRAWINGS

FIG. 1. Schematic diagram of high throughput protein sample preparation system for the treatment of proteins from body fluids, including high-abundance protein depletion system (A) and protein pretreatment device (B): (1) HPLC pumps; (2) Ten-port valve; (3) High-abundance protein depletion column; (4) clustered hollow fiber membranes; (5) denaturation and reduction reaction chamber; (6) temperature control device (7) inlet of denaturing and reducing reagents; (8) the outlet of denaturing and reducing reagents; (9) solvent exchange chamber; (10) the inlet of weak alkaline buffer solution; (11) the outlet of weak alkaline buffer solution; (12) immobilized enzymatic reactor.

FIG. 2. LC-MS analysis of digests from transferrin treated by protein sample preparation device

FIG. 3. LC-MS analysis of digests from low abundance proteins from human plasma treated by protein sample preparation device. a: UV chromatogram of human plasma by antibody column; b: After treatment by the protein sample preparation device, the digests were analyzed by LC-MS.

FIG. 4. LC-MS analysis of low abundance proteins from human urine treated by protein sample preparation device

FIG. 5. LC-MS analysis of low abundance proteins from human serum treated by protein sample preparation device

### DETAILED DESCRIPTION OF THE EMBODIMENTS

### Embodiment 1

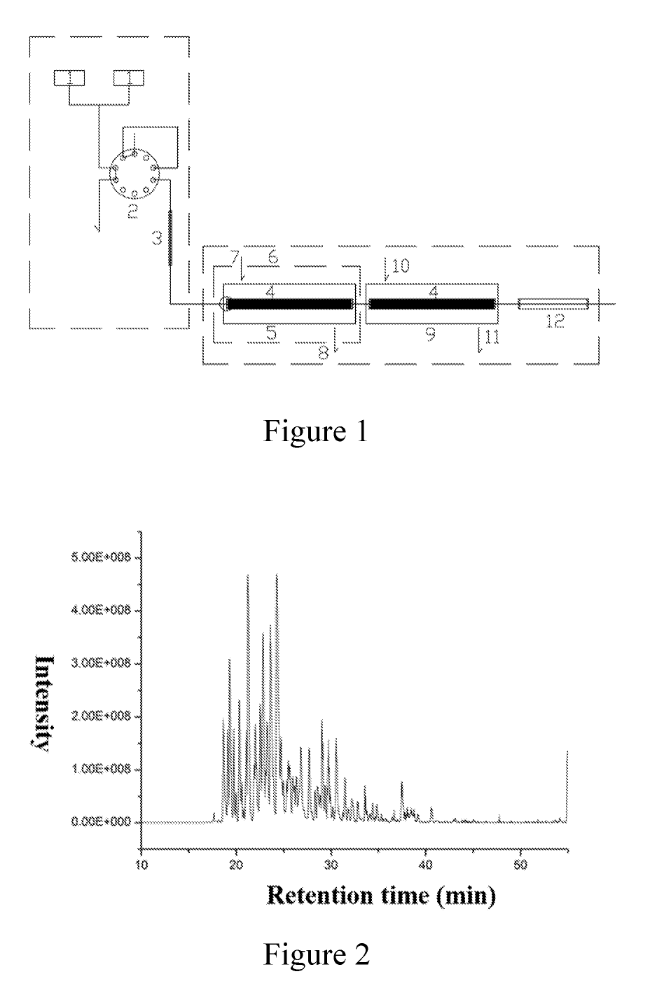

Five hollow fiber membranes are clustered and used as a transport carrier for low-abundance proteins in body fluid, and fixed in a chamber to form protein denaturator and reducer; five hollow fiber membranes are clustered and used as a transport carrier for low-abundance proteins in body fluids, and fixed in chamber to form solvent exchanger. The enzyme reactor is developed with 10 μm silica gel particle materials as matrix materials. The above-mentioned proteins denaturator and reducer, the solvent exchanger and the immobilized enzymatic reactor are sequentially connected in series to construct protein sample pretreatment device. The performance of protein sample pretreatment device (FIG. 1B) was evaluated by using transferrin as a sample. 0.5 mg/mL transferrin (100 μg) was introduced into protein denaturation and reduction device at the flow rate of 150 μL/min, which was heated to 90° C. Guanidine hydrochloride (6 M) and dithiothreitol (DTT, final concentration is 50 mM) in the reaction buffer can enter the membrane by forced convection. After that, the excessive denaturants and reductants in samples were exchanged by the solvent exchanger with 50 mM ammonium bicarbonate (pH 8.0), which was compatible with tryptic digestion. High-concentration denaturing agents and reducing agents are removed by forced convection. Finally, the protein sample realized on-line enzymolysis at room temperature through an immobilized enzyme reactor of silica gel matrix (2.0 mm i.d.×50 mm). The peptides produced by enzymolysis were detected by nanoscale liquid chromatography-mass spectrometry (as shown in FIG. 2). It can be seen from the figure that transferrin was completely converted into peptides with a sequence coverage of 76%.

### Embodiment 2

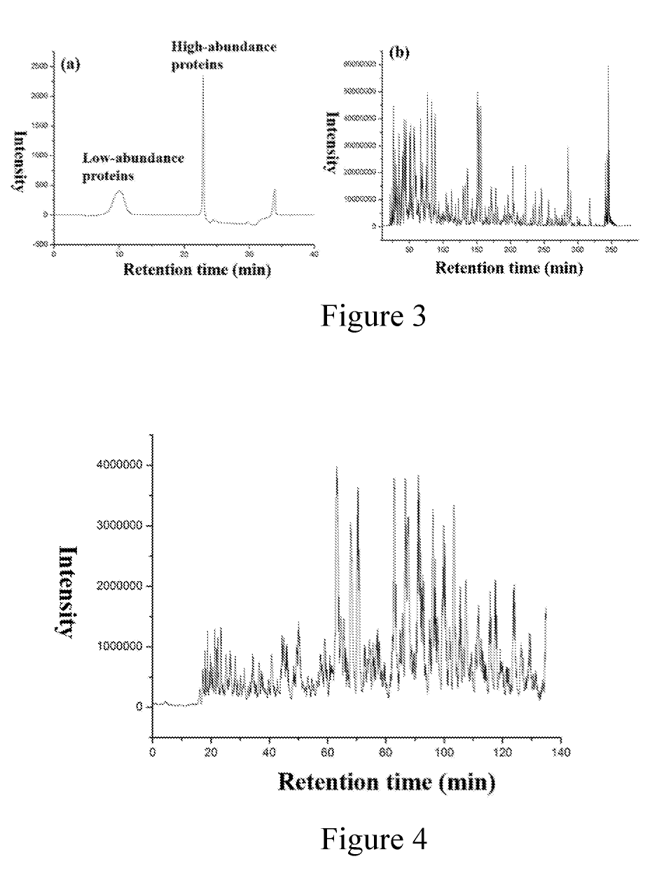

Fifty hollow fiber membranes are clustered and used as a transport carrier for low-abundance proteins in body fluid, and fixed in a chamber to form protein denaturator and reducer; fifty hollow fiber membranes are clustered and used as a transport carrier for low-abundance proteins in body fluids, and fixed in chamber to form solvent exchanger. the enzyme reactor is developed with 20 μm silica gel particle materials as matrix materials. The above-mentioned proteins denaturator and reducer, the solvent exchanger and the immobilized enzymatic reactor are sequentially connected in series to construct protein sample pretreatment device. With combination of the high-abundance protein depletion column and protein sample pretreatment device, a high throughput body fluid protein processing system is constructed (FIG. 1). Human plasma as a sample was processed, and the low-abundance proteins to were analyzed. The operation procedures are as follows: high-abundance proteins from human plasma were first depleted by an antibody column (FIG. 3a), and the collected medium and low-abundance protein fractions are introduced into the device (the operation procedures are the same as those used in Embodiment 1). The peptides were captured by a C18 precolumn and then subjected to LC-MS analysis, as shown in FIG. 3b.

### Embodiment 3

One hundred hollow fiber membranes are clustered and used as a transport carrier for low-abundance proteins in body fluid, and fixed in a chamber to form protein denaturator and reducer; fifty hollow fiber membranes are clustered and used as a transport carrier for low-abundance proteins in body fluids, and fixed in chamber to form solvent exchanger. the enzyme reactor is developed with 30 μm silica gel particle materials as matrix materials. The above-mentioned proteins denaturator and reducer, the solvent exchanger and the immobilized enzymatic reactor are sequentially connected in series to construct protein sample pretreatment device. With combination of the high-abundance protein depletion column and protein sample pretreatment device, a high throughput body fluid protein processing system is constructed. Human urine as a sample was processed, and the low-abundance proteins to were analysed. The operation procedures are as follows: Human urine as a sample to were analyzed. The experimental conditions are as follows: High-abundance proteins from human urine were first depleted by an antibody column (FIG. 3a), and the collected medium and low-abundance protein fractions are introduced into the device at the flow rate of 50 μL/min, which was heated to 75° C. 8 M urea and 50 mM thiol in the reaction buffer can enter the membrane by forced convection; After that, the excessive denaturants and reductants in samples were exchanged by the solvent exchanger with 80 mM ammonium bicarbonate (pH 7.5) (the operation procedures are the same as those used in Embodiment 1). Finally, the protein sample was passed through immobilized enzymatic reactor. The resulting peptides were captured by a C18 precolumn and then subjected to LC-MS analysis, as shown in FIG. 4.

### Embodiment 4

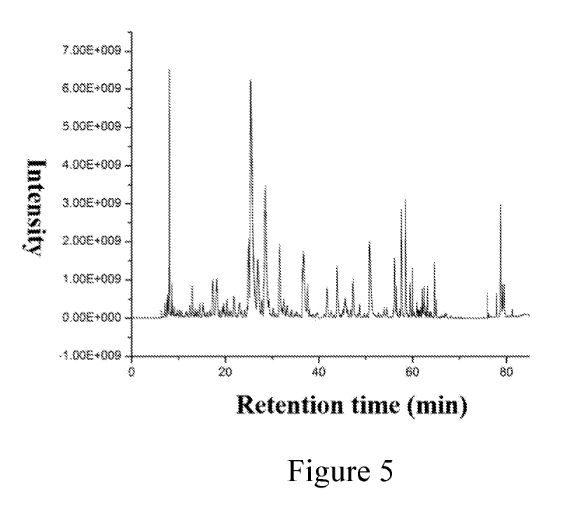

Eighty hollow fiber membranes are clustered and used as a transport carrier for low-abundance proteins in body fluid, and fixed in a chamber to form protein denaturator and reducer; one hundred hollow fiber membranes are clustered and used as a transport carrier for low-abundance proteins in body fluids, and fixed in chamber to form solvent exchanger. the enzyme reactor is developed with 20 μm silica gel particle materials as matrix materials. The above-mentioned proteins denaturator and reducer, the solvent exchanger and the immobilized enzymatic reactor are sequentially connected in series to construct protein sample pretreatment device. With combination of the high-abundance protein depletion column and protein sample pretreatment device, a high throughput body fluid protein processing system is constructed. Human serum as a sample to were analyzed. Human serum as a sample was processed, and the low-abundance proteins to were analyzed. The operation procedures are as follows: High-abundance proteins from human serum were first depleted by an antibody column (FIG. 3a), and the collected medium and low-abundance protein fractions are introduced into the device at the flow rate of 100 μL/min, which was heated to 85° C. 4 M urea and 50 mM TCEP in the reaction buffer can enter the membrane by forced convection; After that, the excessive denaturants and reductants in samples were exchanged by the solvent exchanger with 80 mM ammonium bicarbonate (pH 8.5), which was compatible with tryptic digestion, other operation procedures are the same as those used in Embodiment 1. Finally, the protein sample was passed through immobilized enzymatic reactor. and the resulting peptides were captured by a C18 precolumn and then subjected to LC-MS analysis, as shown in FIG. 5.

1. A high-throughput sample pretreatment device for the processing of proteins from body fluids should be composed of (A) high-abundance protein depletion system and (B) protein sample pretreatment device, both are sequentially connected in series;
wherein: the protein sample pretreatment device comprises a high temperature denaturator and reducer, a solvent exchanger and an immobilized enzymactic reactor, which are sequentially connected in series; A high temperature denaturator and reducer comprises more than two hollow fiber membranes and a denaturation and reduction reaction chamber;
Two or more hollow fiber membranes are bundled in a polytetrafluoroethylene tube, both end of which were glued by epoxy gel, and then fixed in the denaturation and reduction reaction chamber; The clustered hollow fiber membranes were used as protein transport carriers, and both ends of the clustered hollow fiber membrane protrude out of the chamber;
the inlet and outlet of reaction buffers are provided on the side wall of the denaturation and reduction reaction chamber; An electric heating film is provided on the outer wall of the denaturation and reduction reaction chamber;
The solvent exchanger comprises two or more hollow fiber membranes and a solvent exchange chamber; Two or more hollow fiber membranes are clustered in a polytetrafluoroethylene tube, both end of which are glued by epoxy gel, and then fixed in the solvent exchange chamber; The clustered hollow fiber membranes are used as protein transport carriers, and both ends of the clustered hollow fiber membrane protrude out of the chamber; The inlet and outlet of exchange buffers are provided on the side wall of the chamber;
The high-abundance protein depletion system (A) consists of an antibody column and HPLC pumps; One end of the column is connected with body fluid protein sampler through HPLC, another end of the column is connected with the protein sample pretreatment device (B);
The high-throughput body fluid protein sample pretreatment device connects the inlet end of the high-abundance protein depletion column and body fluid proteins sampler; The middle and low-abundance proteins eluted from the column directly enters the high temperature denaturator and reducer, the outlet of the hollow fiber membrane in denaturator and reducer is in connection with inlet of the hollow fiber membrane in the solvent exchanger; and the outlet of the hollow fiber membrane in the solvent exchanger connects with the inlet of enzymatic reactor; the product is eluted from the outlet of the enzymatic reactor; The middle and low-abundance proteins passes the enzymatic reactor and are rapidly cleaved into peptides to achieve rapid conversion of middle and low-abundance proteins to peptides;
the material inlet of the clustered high temperature denaturator and reducer is connected to the denaturation and reduction reaction liquid, and the outlet is a waste liquid outlet;
a buffer solution replacement chamber is provided with the material inlet connected to a solvent replacement liquid, and an outlet is a waste liquid outlet.

2. The protein sample pretreatment system according to claim 1, wherein 2-100 hollow fiber membranes are clustered and used as a transport carrier for low-abundance proteins, and fixed in chamber to form protein denaturation and reduction chamber; High-concentration denaturing agents and reducing agents are pumped into the chamber by liquid chromatography pump or peristaltic pump, and rapidly mixed with the proteins, followed by heating by the temperature control system, to achieve fast protein denaturation and reduction;
2-100 hollow fiber membranes are clustered and used as a transport carrier for low-abundance proteins in body fluids, and fixed in chamber to form solvent exchanger; Low-concentration weak alkaline buffer solution is delivered to the chamber through a liquid chromatography pump or a peristaltic pump to replaces the protein solvent with the exchange buffer to achieve protein desalting;
The matrix material of the enzyme reactor is a silica gel particle material with a particle diameter of 10-30 μm; the protease is immobilized on the surface of the material by covalent bonding, the enzyme is trypsin, and the concentration of the enzyme solution is 10-50 mg/mL;
The above-mentioned proteins denaturator and reducer, the solvent exchanger and the immobilized enzymatic reactor are sequentially connected in series to construct protein sample pretreatment device.

3. The protein sample pretreatment system according to claim 1, wherein the flow rate range of liquid chromatography pump or peristaltic pump 0.1 mL/min-5 mL/min, Temperature range of heating by temperature control device is 60-95° C.;
wherein the type of the denaturants may be guanidine hydrochloride or urea, the concentration is 4-8M, and the type of the protein reducing agents may be dithiothreitol, thiol, tris(2-carboxyethyl)phosphine (TCEP), the concentration is 5-100 mM; The low concentration alkaline buffer solutions may be ammonium hydrogencarbonate or ammonium acetate solution, the concentration range is 10-100 mM, and the pH range is 7.5-8.5.

4. The protein sample pretreatment system according to claim 1, wherein the flow rate suitable for antibody column is ranging from 50 to 1000 μL/min; the amount of proteins processed by the protein sample pretreatment system ranges from 0.3 to 1 mg; body fluids include plasma, serum or urine.

5. The protein sample pretreatment system according to claim 1, wherein the protein sample pretreatment system can be used for fast protein processing in clinical diagnosis and clinical proteomics research.
